(19) United States
(12) Patent Application Publication
(10) Pub. No.: US 2016/0044585 A1
(43) Pub. Date: Feb. 11, 2016

(54) ESTABLISHING A LINK IN A MESH NETWORK

(71) Applicant: HANGZHOU H3C TECHNOLOGIES CO., LTD., Hangzhou, Zhejiang (CN)

(72) Inventor: Guoxiang XU, Beijing (CN)

(21) Appl. No.: 14/768,710

(22) PCT Filed: Mar. 3, 2014
(86) PCT No.: PCT/CN2014/072791

§ 371 Date: Aug. 18, 2015

(30) Foreign Application Priority Data
Mar. 4, 2013 (CN) 201310068828.6

(51) Int. Cl. H04W 48/16; H04W 76/02; H04W 72/08

(52) U.S. Cl. CPC H04W 48/16; H04W 72/085; H04W 76/02; H04W 84/18

(57) ABSTRACT

A mobile mesh point is mobile with respect to a first connecting mesh point and a second connecting mesh point. While the mobile mesh point has a mesh link with the first connecting mesh point, the mobile mesh point scans for a connecting mesh point with which it may establish a mesh link. On detecting the second connecting mesh point, the mobile mesh point may establish a virtual mesh link between the mobile mesh point and the second connecting mesh point by exchanging messages between the mobile mesh point and the second connecting mesh point via the first connecting mesh point. The messages exchanged comprise messages to establish a real mesh link. The virtual mesh link may be transformed to a real mesh link between the mobile mesh point and the second connecting mesh point.

### BACKGROUND

Mesh networks are networks comprising a plurality of nodes in which each node relays data through the network. A wireless mesh network is a mesh network in which the nodes are connected by wireless links. The nodes may for example be access points through which a wireless client device, such as a computer, tablet device, smart phone etc. may access the wireless network. The wireless connections may for example be established according to a WLAN (Wireless Local Area Network) standard. In a wireless mesh network, a plurality of access points may connect to each other wirelessly in order to relay data through the network. In that case, each access point may be referred to as a mesh point.

### BRIEF DESCRIPTION OF THE DRAWINGS

The present disclosure is explained in detail, by way of example only, with reference to the accompanying drawings, in which:

FIG. 1 is a schematic drawing of a mesh network;

FIG. 2 is a flow chart of a method for establishing a mesh link;

FIG. 3 is a schematic drawing of a mesh network;

FIG. 4 is a flow chart of a method for establishing a mesh link;

FIG. 5 is an example of a data frame format;

FIG. 6 is an example of the format of the content of a field of the data frame format shown in FIG. 5;

FIG. 7 is a schematic drawing of a process for establishing a mesh plaintext link;

FIG. 8 is a schematic drawing of a process for establishing a mesh safe link using SAE authentication;

FIG. 9 is a schematic drawing of a process for establishing a mesh safe link using 802.1X authentication;

FIGS. 10 to 12 are schematic drawings of the structure of examples of a mobile mesh point; and

FIG. 13 is a schematic drawing of the structure of an example of a connecting mesh point.

### DETAILED DESCRIPTION OF THE INVENTION

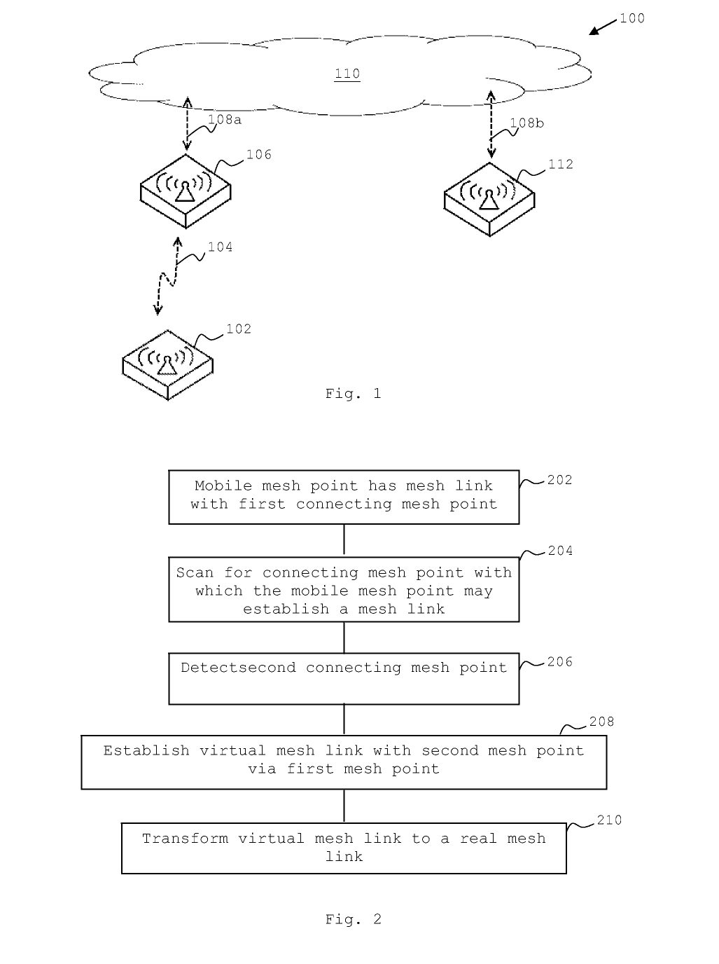

FIG. 1 shows a mesh network 100 in which a mobile mesh point 102 has a mesh link 104 with a first connecting mesh point 106. The first connecting mesh point 106 has a communication link 108a with a communications network 110. A second connecting mesh point 112 also has a communication link 108b with the communications network 110.

The communications network 110 could be any network, for example comprising a wired or wireless network, or a combination of such networks. Likewise, the communication links 108a, 108b may be wired links, or wireless connections, or a combination of such connections. In one example, the communications network 110 and communication links 108a, 108b comprise wired connections.

The communication links 108a and 108b together with the communications network 110 provide what in a mesh network is referred to as a ‘distributed system’. The distributed system allows mesh points 102, 106, 112 to communicate with one another and therefore provides an example of a link between the first 106 and second 112 connecting mesh points, although alternative links may be provided. The distributed system may also provide access to data or to other networks, for example providing access to resources desired by or requested via the mobile mesh point 102.

A distributed system may comprise any number of communication links of any type, between any number of processing devices. The system may be dynamic, with processing devices such as computers, servers, routers, etc. joining and leaving the system.

In one example, a mesh network 100 may be provided in an environment such as in a subway tunnel or along another transport route such as a road, where a mobile mesh point 102 may move relative to connecting mesh points 106, 112, which in such a network are fixed mesh points. For example, a mobile mesh point 102 may be provided in a vehicle, and connecting mesh points 106, 112 arranged along a transport route. A mesh link 104 may then formed between an on-vehicle mobile mesh point 102 and each on-route fixed, connecting mesh point 106, 112 in turn so as to provide a data connection to the inside of the vehicle (for example, allowing passengers to access the Internet).

In one example the mobile mesh point may for example be an access point in an underground train carriage and the fixed connecting mesh points may be access points fixed to tunnel walls or otherwise placed in fixed locations along the train route. Of course the teachings herein may be applied to other modes of transport as well, such as overground trains, coaches, cars etc.

In an example, the user may move out of range of the first connecting mesh point 106 and towards the second connecting mesh point 112. As the user does so, a connection to the second connecting mesh point 112 may be established and the connection with the first connecting mesh point 106 may be lost.

To prevent interruption in the data communication, or ‘mesh link switch’, the changeover from an existing mesh link to a new mesh link should be fast. However, establishing such a link (in particular, if data protocols ensuring the link is a safe link are followed) will usually involve one or more exchanges of messages. In addition, in order to prevent interference between mesh points, it is likely that, at least sometimes, two adjacent connecting mesh points 106, 112 will be operating on different communication channels (i.e. differing wavebands may be used for transmissions sent or received by different mesh points). This exchange of messages, and the possible need to switch communication channels, takes time, and can result in a noticeable interruption in communication services. This might be particularly apparent for a user accessing voice or video data.

To consider communication channels further, if, for example, a Wireless Local Area Network (WLAN) is operating on the Industrial, Scientific and Medical (ISM) frequency band, and all connecting mesh points 106, 112 operate on one communication channel, auto-interference will likely occur. In addition, interference from other radio frequency signals of the same frequency cannot be effectively avoided in some segments of the route. However, if the channel associated with a particular mesh point 102, 106, 112 can change, for example being adjusted dynamically, this may allow a mesh point 102, 106, 112 to avoid interference from a new external source of interference, or from another mesh point 102, 106, 112 (which may itself have changed channel), or another source of interference. Configuring connecting mesh points 102 to use different communication channels from one another limits auto-interference within the network and allows external interference to be mitigated.

Although as described herein, the communication network 110 is accessed via a mesh point designated a ‘connecting’ mesh point 106, 112, this terminology does not imply any particular features, other than that the mesh points so labelled are capable of acting as mesh points in a mesh network. In some examples, the connecting mesh points are fixed mesh point, i.e. they are installed at a generally fixed location.

One example of a method of establishing a mesh link between a mobile mesh point 102 and a new connecting mesh point 112 is now described with reference to the flow chart in FIG. 2. As in FIG. 1, the mobile mesh point 102 has a mesh link 104 with the first connecting mesh point 106 (block 202). In such networks, the connection to the first connecting mesh point 106 may become less favourable, for example if the mobile mesh point 102 is moving away from the first connecting mesh point 106, attenuation between the mobile mesh point 102 and the first connecting mesh point 106 increases, the first connecting mesh point 106 becomes oversubscribed, or for some other reason. In block 204, the mobile mesh point 102 scans for any other connecting mesh points with which the mobile mesh point 102 may establish a mesh link. This leads, in block 206, to detection of the second connecting mesh point 112.

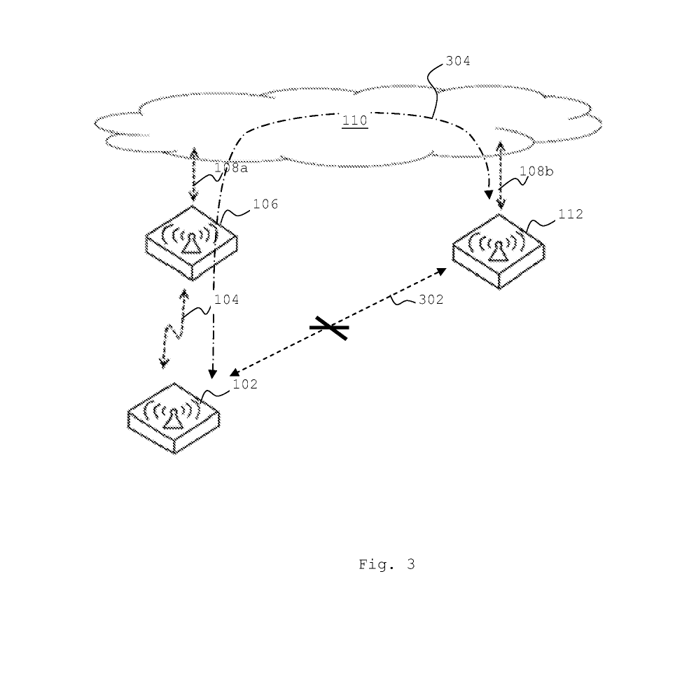

In this example, the process of establishing a mesh link between the mobile mesh point 102 and the second connecting mesh point 112 continues in block 208 by establishing a virtual mesh link 302 as shown schematically in FIG. 3. This is achieved by exchanging messages 304 between the mobile mesh point 102 and the second connecting mesh point via the first connecting mesh point 106. These messages 304 are at least some of the same messages for establishing a real mesh link. The messages 304 are not exchanged directly between the mobile mesh point 102 and the second connecting mesh point 112, instead passing via the first connecting mesh point 106, and, in this example the distributed system. Once the virtual mesh link 304 is established, as at least some of the messages to be exchanged between the mobile mesh point 102 and the second connecting mesh point 112 to establish a real mesh link have already been exchanged, it may be relatively quickly transformed to a real mesh link 104, directly connecting the mobile mesh point 102 to the second connecting mesh point 112.

In this example, a virtual mesh link 302 is distinguished from a real mesh link 104 at least in that it does not transmit data messages (and is therefore illustrated with a X struck there through in FIG. 3). In order to prevent data from being exchanged over the virtual link 302, the link 302 may be marked with a related indication, which may, for example, simply be data bit indicating to the network components that it is not to be used to transmit data messages.

Once established, such a virtual mesh link 302 may be transformed to a real mesh link 104 (block 210). This transformation may comprise, for example, changing the indication described above. The indication may be provided at or by one or both of the mobile mesh point 102 and the second connecting mesh point 112. In some examples, the method may further comprise switching the mobile mesh point 102 to a communication channel of the second connecting mesh point 112 and, on transforming said virtual mesh link 304 into a real link, starting to forward data messages.

In this example, the messages 304 to establish the virtual link 302 include authentication messages, and may be part of a ‘handshake’ protocol. In some examples, the messages 304 exchanged to establish a virtual mesh link 104 comprise all of the messages which might be exchanged between two mesh points 102, 112 to establish a mesh link 104 therebetween. However, it will be noted that these messages 304 are not transmitted directly, for example wirelessly, between the mobile mesh point 104 and the second connecting mesh point 112, but instead are sent via the distributed system provided, in this example, by the communication links 108a, b and the communications network 110. Examples of the messages which may be exchanged are provided below in relation to FIGS. 7 to 9.

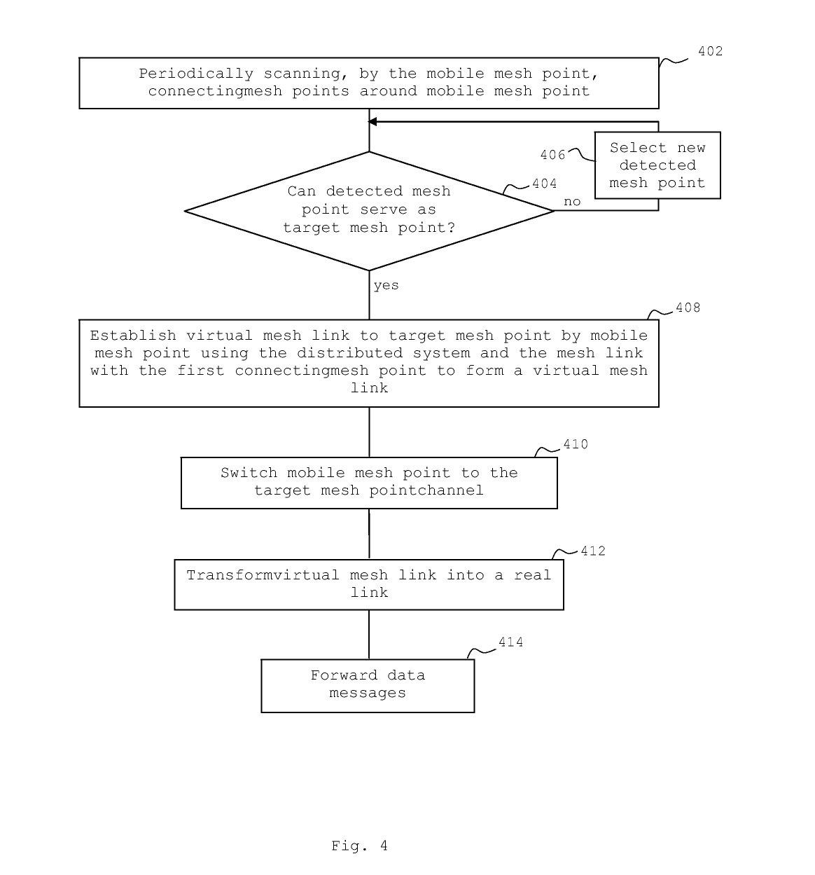

In FIG. 4, a further example of a method for establishing a mesh link is described. The method is carried out in a WLAN mesh network comprising at least one mobile mesh point 102 and several connecting mesh points 106, 112, which in this example are fixed mesh points that can establish mesh links to the mobile mesh point 102. The mobile mesh point 102 has already established a mesh link 104 to a first of the connecting mesh points 106 for providing WLAN data communication.

In block 402, the mobile mesh point 102 scans for connecting mesh points around the mobile mesh point 102 periodically. Once at least one connecting mesh point has been detected, it is determined, in block 404, for each detected mesh point, whether that mesh point can serve as a target mesh point for a mesh link switch (i.e. if the detected connecting mesh point can serve as a connection between the mobile mesh point 102 and the communications network 110). If yes, the method proceeds to block 406. Otherwise, that mesh point is ignored and it is determined whether other connecting mesh points can serve as target mesh points for a mesh link switch (block 406).

In one example, the mobile mesh point 102 scans the connecting mesh points around it one by one according to a pre-set scanning period. When it is discovered after such scanning that a detected connecting mesh point has a signal strength that reaches a predetermined first threshold, that connecting mesh point can be used as a target connecting mesh point for a mesh link switch and block 408 will be performed as described below. If no connecting mesh point is discovered by scanning, or connecting mesh point(s) 112 are discovered but their signal strengths do not reach the predetermined first threshold, then the mobile mesh point 102 may restart a new scanning process for connecting mesh points 106, 112 around it when the next scanning period starts.

Assuming a suitable target connecting mesh point has been identified, the method proceeds as in block 408 by establishing a virtual mesh link to the target connecting mesh point (e.g. the second connecting mesh point 112). The virtual mesh link 302 between the mobile mesh point 102 and the target mesh point 112 is established via the distributed system provided, in this example, by the communication links 108a, 108b, and the communications network 110, and via the mesh link 104 that has already been established between the mobile mesh point 102 and the first connecting mesh point 106. This means that it is not established, for example, directly through ‘over the air’ communications between the mobile mesh point 102 and the target mesh point 112.

In one example, the virtual mesh link 302 is established using an Ether frame type as now described. A message carrying such an Ether frame type can perform mesh peer management, mesh authentication, and/or mesh four-way key handshake protocol interaction between the mobile mesh point 102 and the target mesh point 112 through the distributed system provided by the communication links 108a,b, communications network 110 and through the mesh link 104 between the mobile mesh point 102 and the first connecting mesh point 106. In this example, the frame complies with 802.11 Mesh data frame format when being transmitted on a mesh link, and has fields as shown in FIG. 5.

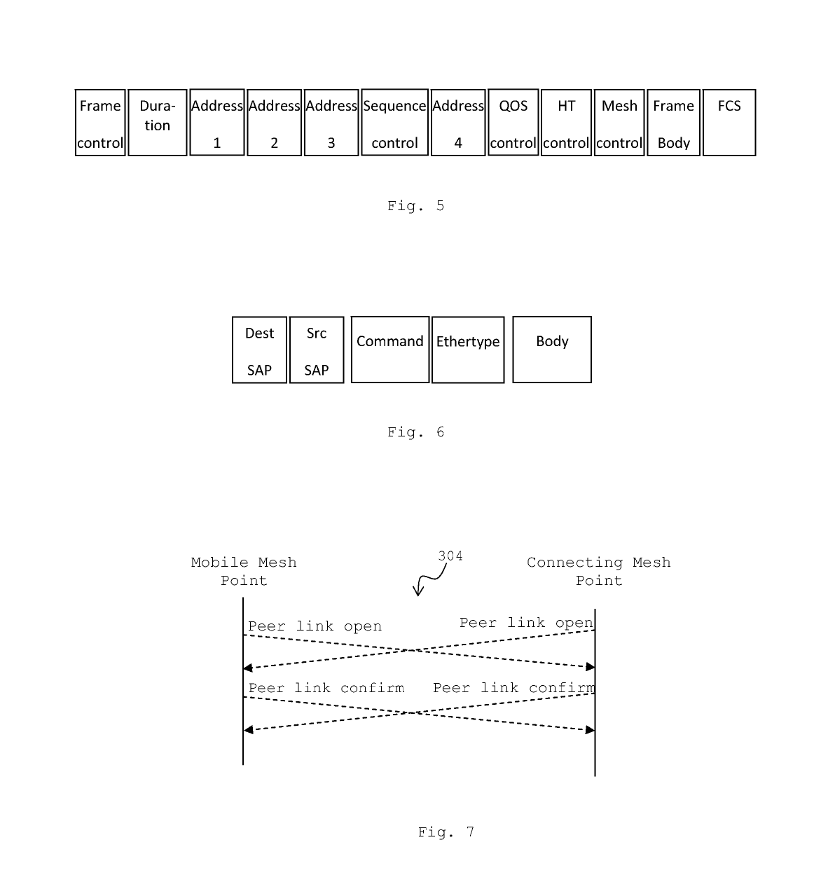

In this example, the Mesh Control field shown in FIG. 5 carries fields Address 5 and Address 6, which indicate the real source Media Access Control (MAC) address and destination MAC address of the message. The Frame Body field includes a Logical Link Control (LLC) header of an 802.11 format frame, in this example having the fields as shown in FIG. 6.

In FIG. 6, the Ether type field is a value indicative of the Ether frame type set out herein and the mesh management frame exchanged between the mobile mesh point 102 and the target mesh point 112 for the purpose of establishing the virtual mesh link 302 is encapsulated using this newly defined Ether type value.

In this example, a mesh peer management message, mesh authentication message, and/or mesh four-way key handshake protocol message for completing establishment of a mesh link may all be directly encapsulated in a Body field of the frame. A first byte of the Body field may be an Action field which may be used to differentiate the protocols. Thus when the target mesh point 112 receives a frame and determines that the destination MAC is that target mesh point 112 itself, it is understood as meaning that the mobile mesh point 102 wants to establish a virtual link to the target connecting mesh point 112 through the distributed system. If however a mesh point receives such a frame but discovers that the destination MAC is not itself, it will forward said frame according to the destination MAC.

Examples of processes for establishing a virtual link are illustrated in FIGS. 7 to 9. As these examples show, this virtual link may be established with or without authentication.

FIG. 7 shows a process for establishing an unauthenticated mesh ‘plaintext’ link, in which messages 304 are exchanged to first open, and then confirm a peer link.

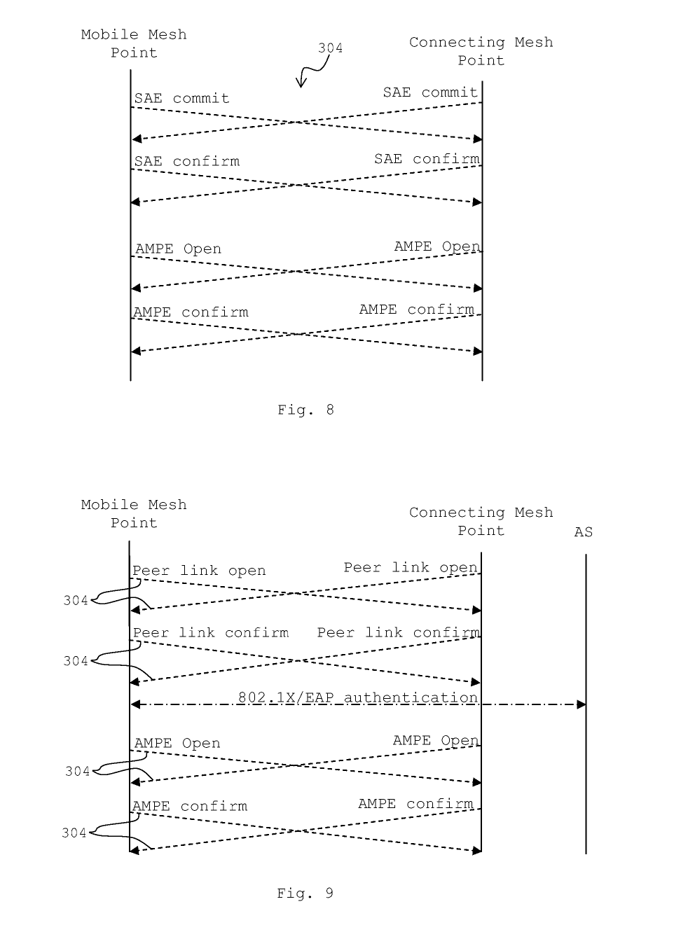

FIG. 8 shows how a mesh safe link may be established using a ‘Simultaneous Authentication of Equals’ (SAE) authentication process, for example as part of an implementation of IEEE 802.11s protocols, in which first SAE and then Authenticated Mesh Peering Exchange (AMPE) messages are exchanged.

FIG. 9 shows how a mesh safe link may be established under a 802.1X authentication. Messages are exchanged between the mobile mesh point 102 and the second connecting mesh point 112, first to open and then confirm a peer link. Following this, Extensible Authentication Protocol (EAP) messages are sent from the mobile mesh point 102 to an authentication server AS. Finally, AMPE open and confirm messages are exchanged between the mobile mesh point 102 and the second connecting mesh point 112.

It can therefore be appreciated that, in the examples of FIGS. 7 to 9, a ‘safe link’ is an authenticated link, whereas a ‘plaintext’ link does not require authentication.

Although exchange of such messages 304 will be familiar from establishing a standard mesh link, in order to avoid disordered data transmission caused by data messages being transmitted through different mesh links, the link between the mobile mesh point 102 and target mesh point 112 is configured so as to prevent the forwarding of WLAN data messages, and is therefore referred herein as a virtual mesh link.

However, in this example, once the virtual link 302 exists, a ‘real’ link that can be used to send data messages may be established as follows. The mobile mesh point 102 is switched (e.g. retuned) to the channel of the target connecting mesh point 112 (block 410); and the virtual mesh link 302 is transformed into a real link (block 412), which can forward data messages (block 414).

In one example, at least one of blocks 410, 412 and 414 follow a determination that the signal strength of the target mesh point 112 (which may be scanned continuously, or in some other way) reaches or exceeds a predetermined second threshold (which may be larger than the predetermined first threshold mentioned above).

Since a virtual link 302 (e.g. a mesh plaintext link or mesh safe link as described above) already exists between the mobile mesh point 102 and the target mesh point 112, the mobile mesh point 102 performs a channel switch, rather than also exchanging messages to open and/or authenticate a link.

After the channel switch of the mobile mesh point 102, the virtual mesh link 302 established to the target mesh point can operate as a ‘real’ mesh link and can be used to actually forward data. The mobile mesh point 102 directly forwards messages, for example wirelessly, by means of the mesh link established to the target mesh point 112. Upon receiving the data messages sent by the mobile mesh point 102 through said mesh link, the target mesh point may also transform the mesh virtual link 302 into an actual link 104 to start to forward data messages.

Assuming that all of the messages 304 necessary to establish a real link have been exchanged to establish the virtual link 302, such a link 302 may be transformed from a virtual to a real link for example by changing an indication. For example, a bit may be provided to mark the link as a virtual or a real link, and could be changed from 0 to 1 or vice versa to transform the link 302.

In this example therefore, a mobile mesh point 102 periodically scans for connecting mesh points around it. When a target mesh point (e.g. the second connecting mesh point 112) is discovered for a mesh link switch, a virtual link is established with this target mesh point, in this example in the form of a mesh plaintext link or safe link, using the distributed system provided by the communications network 110 and the mesh link that is already established (i.e. the mesh link with the first connecting mesh point 106) so as to form a virtual mesh link 302. When said mobile mesh point 102 moves into the range of the target mesh point 112, it can quickly and smoothly transform the virtual mesh link 302 into a ‘real’ mesh link 104 that can actually forward data, thereby limiting data communication interruption.

Therefore, in some examples described herein, the establishment of a virtual mesh link between the mobile mesh point 102 and the target mesh point 112 includes carrying out authentication between the mobile mesh point 102 and the target mesh point 112 before a real mesh link exists therebetween. Subsequently, when such a real mesh link is established, no authentication needs to be performed between the mobile mesh point 102 and the target mesh point 112 in order to provide an authenticated link, and as a result, time may be saved when the mesh link switch occurs.

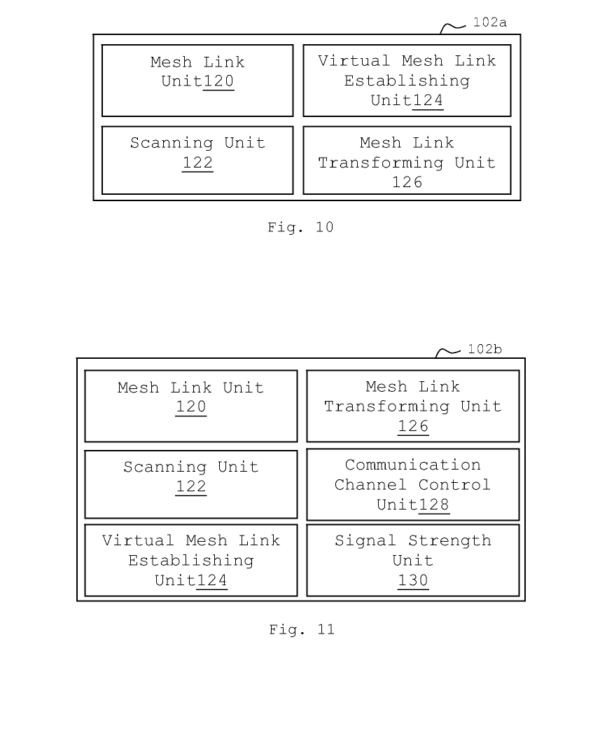

FIG. 10 shows a schematic drawing of the structure of an example of a mobile mesh point 102a for use in a mesh network 100, for example comprising a logical apparatus formed by a CPU in the mobile mesh point 102a executing computer instructions in a memory.

In this example, the mobile mesh point 102a comprises a mesh link unit 120 to exchange data messages over a mesh link 104 with a connecting mesh point 106, 112. The mobile mesh point further comprises a scanning unit 122 to detect connecting mesh points with which a mesh link may be established. The scanning unit 122 may be a signal scanning unit, which may listen for, and/or request, messages or signals from connecting mesh points. In some examples, the messages may be probe messages, or probe response messages.

The mobile mesh point 102a also comprises a virtual mesh link establishing unit 124 to establish a virtual mesh link 302, and a mesh link transforming unit 126 to transform the virtual mesh link 302 to a real mesh link 104. The mobile mesh point 102a is arranged such that if, in use of the mobile mesh point 102a and while the mobile mesh point 102a has an existing mesh link 104 with a first connecting mesh point 106, and the signal scanning unit 122 detects a second connecting mesh point 112, the virtual mesh link establishing unit 124 may establish a virtual mesh link 302 to the second connecting mesh point 112 via the existing mesh link 104, and the mesh link transforming unit 126 may transform the virtual mesh link 302 into a real mesh link. Establishing a virtual link may comprise exchanging messages as described in relation to FIGS. 7 to 9 above. Transforming the mesh link may for example comprise changing an indication associated with the virtual mesh link 302 to indicate that it may be used to transmit data messages.

FIG. 11 shows a further example of a mobile mesh point 102b which comprises the features described in relation to the mobile mesh point 102a of FIG. 10. In addition, in this example, the signal scanning unit 122 also determines the communication channel of a connecting mesh point 106, 112 (which in some examples may be contained in messages or signals received therefrom, or detectable from analysis of the message or signals themselves). Further, the mobile mesh point 102b comprises a communication channel control unit 128 to change the communications channel on which messages are sent by the mobile mesh point 102b if the first connecting mesh point 106 has a different communication channel that the second connecting mesh point 112. This may comprise, for example, retuning a transmitter and/or receiver of the mobile mesh point 102b.

In this example, the mobile mesh point 102b also comprises a signal strength unit 130 to determine the strength of a signal from a connecting mesh point 106, 112 and the virtual mesh link establishing unit 124 establishes a virtual mesh link 302 if a signal strength reaches or exceeds a predetermined threshold. Further, in this example, the virtual mesh link transforming unit 126 transforms the virtual mesh link 302 to a real mesh link 104 if the signal strength reaches or exceeds a predetermined threshold. The strength of a received signal may, for example, be determined using the power and/or signal to noise ratio of a received signal, which may be a signal received from the second connecting mesh point 112 (such as a broadcast ‘probe’ message or the like), or based on a signal exchange with the second connecting mesh point 112 or in some other way.

In some examples, the virtual mesh link establishing unit 124 carries out all authentication processes between the mobile mesh point 102b and a target mesh point to establish a mesh link therebetween. Therefore, authentication need not be carried out at the time a real link is established by the mesh link transforming unit 126 to establish an authenticated link, and the mesh link transformation may be carried out quickly.

In one example, after forming a virtual mesh link 302 between the mobile mesh point 102a and a target connecting mesh point 112, the signal strength unit 130 will further monitor the signal strength of the target connecting mesh point 112 continuously to determine when the signal strength of the target mesh point reaches or exceeds a predetermined second threshold (which is larger than the predetermined first threshold). Following such a determination, if the mobile mesh point 102 is on a different channel to that of a target connecting mesh point 112, the channel control unit 128 of mobile mesh point 102 switches the operating channel of the mobile mesh point 102 to the channel of the target connecting mesh point 112. After the channel switch of the mobile mesh point 102, the link established to the target connecting mesh point 112 may be used for data forwarding. The mobile mesh point 102 directly forwards messages wirelessly to the connecting mesh point 112.

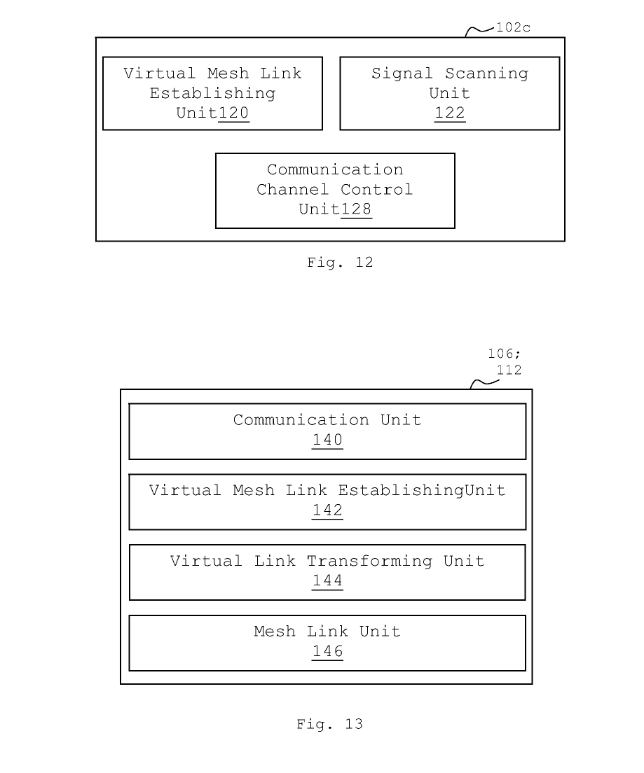

FIG. 12 shows a further example of a mobile mesh point 102c for fast link establishment in a WLAN mesh network, said WLAN mesh network including at least one mobile mesh point 102 and several fixed mesh points that can establish mesh links to said mobile mesh point 102c, and said mobile mesh point 102c having already established a mesh link to one of said fixed mesh points for providing WLAN data communication. The mobile mesh point 102c comprises: a signal scanning unit 122, a virtual mesh link establishing unit 120, and a communication channel control unit 128 which serves as a channel switching unit.

In this example, the signal scanning unit 122 periodically scans for fixed mesh points around the mobile mesh point 102c, and also determines whether any detected fixed mesh points 106, 112 can serve as a target mesh point for a mesh link switch. If so, the virtual mesh link establishing unit 120 is controlled to establish a virtual mesh link 302. Otherwise, that mesh point is ignored, and the mobile mesh point 102 determines whether other fixed mesh points can serve as target mesh points for mesh link switch.

The virtual mesh link establishing unit 120 is used by the mobile mesh point 102 to establish a virtual mesh link 302 to the target mesh point using a distributed system and the mesh link already established to the fixed mesh point.

Any of these mobile mesh points 102a, 102b, 102c may serve as a mobile mesh point 102 in the network shown in FIG. 1. Features described in relation to one mobile mesh point 102a, 102b, 102c may be combined with features described in relation to another mobile mesh point 102a, 102b, 102c.

The communication channel control unit 128 switches the mobile mesh point 102c to the communications channel used by the target mesh point and transforms the virtual mesh link 302 into a real link 104, and starts to forward data messages.

FIG. 13 shows an example of a connecting mesh point 106, 112 comprising a communication unit 140 to exchange messages via a further connecting mesh point 106, 112 having a real mesh link to the mobile mesh point 102 (which further connecting mesh point 106, 112 may also comprise a communication unit, and may forward messages to or from the mobile mesh point 102 with which it has a real mesh link), a virtual mesh link establishing unit 142, and a mesh link unit 144.

In use, the communication unit 140 exchanges messages with the mobile mesh point 102 via the further connecting mesh point 102, 112, the messages comprising messages to establish a mesh link between the connecting mesh point 106, 112 and the mobile mesh point 102. The virtual mesh link establishing unit 142 uses the messages to establish a virtual mesh link 302 with the mobile mesh point 102, for example as described in relation to FIGS. 7 to 9 above. The virtual mesh link 302 is transformable into a real mesh link, for example as set out above. A virtual link transforming unit 144 is also provided and, once a message is received directly from the mobile mesh point 102, the connecting mesh point 112 may also transform the virtual mesh link 302 into an actual link, for example by changing an indication associated with the virtual link 302 and indicating that the link 302 should not be used to transmit data to an indication that the link may be used to transmit data.

The mesh link unit 146 may exchange data messages over a mesh link with a mobile mesh point 102, for example once the virtual mesh link 302 has been transformed into a real mesh link 104.

In some of the methods set out above, the mobile mesh point 102 establishes a virtual link 302 to a target connecting mesh point in advance of establishing a real mesh link. The virtual mesh link 302 does not forward data. One or both of the mobile mesh point 102 and the connecting mesh point 112 can transform the virtual mesh link 302 into a real mesh link, i.e. a mesh link that can actually forward data, in good time and in a smooth manner, thereby avoiding or limiting data communication interruption.

The examples of the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. It shall be understood that each flow and/or block in the flow charts and/or block diagrams, as well as combinations of the flows and/or diagrams in the flow charts and/or block diagrams can be realized by machine readable instructions. The machine readable instructions may, for example, be executed by a general purpose computer, a special purpose computer, an embedded processor or processors of other programmable data processing devices to realize the functions described in the description and diagrams. Thus the functional modules or functional units of the apparatus and devices discussed above may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processers.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operation steps to produce computer-implemented processing, thus the instructions executed on the computer or other programmable devices provide a step for realizing functions specified by one or more flows in the flow charts and/or one or more blocks in the block diagrams.

Further, the teachings herein may be implemented in the form of a computer software product, the computer software product being stored in a storage medium and comprising a plurality of instructions for making a computer device (e.g. a personal computer, a server or a network device such as a router, switch, mesh point 112, 106, 112 etc.) implement the methods recited in the examples of the present disclosure.

Although the flow diagrams described above show a specific order of execution, the order of execution may differ from that which is depicted. Functions ascribed to any mobile mesh point 102 in the examples above may be carried out by a connecting mesh point 106; 112 and vice versa. Blocks described in relation to one flow chart may be combined with those of another flow chart.

It should be understood that examples of the method and devices described above are implementation examples only, and do not limit the scope of the disclosure. Numerous other changes, substitutions, variations, alternations and modifications may be ascertained by those skilled in the art, and it is intended that the present disclosure encompass all such changes, substitutions, variations, alterations and modifications as falling within the spirit and scope of the appended claims.

1. A method for establishing a mesh link in a mesh network, the network comprising a mobile mesh point, a first connecting mesh point and a second connecting mesh point, wherein the mobile mesh point is mobile with respect to the first connecting mesh point and the second connecting mesh point, the method comprising:
while the mobile mesh point has a mesh link with the first connecting mesh point, scanning for a connecting mesh point with which the mobile mesh point may establish a mesh link;
detecting the second connecting mesh point;
establishing a virtual mesh link between the mobile mesh point and the second connecting mesh point by exchanging messages between the mobile mesh point and the second connecting mesh point via the first connecting mesh point, said messages comprising messages for establishing a real mesh link;
transforming the virtual mesh link to a real mesh link between the mobile mesh point and the second connecting mesh point.

2. A method according to claim 1 in which each connecting mesh point has an associated communication channel, and the method further comprises determining the communication channel of the second connecting mesh point, and, if the communication channel of the second connecting mesh point is different from the communication channel of the first connecting mesh point, switching a communication channel of the mobile mesh point to the communication channel of the second connecting mesh point.

3. The method of claim 1, in which establishing a virtual mesh link between the mobile mesh point and the second connecting mesh point via the first connecting mesh point comprises exchanging all messages to be exchanged between the mobile mesh point and the second connecting mesh point to establish a mesh link.

4. The method of claim 1 in which the virtual mesh link is associated with an indication that data messages are not to be sent via the mesh link, and the step of transforming the virtual mesh link to a real mesh link comprises changing the indication to an indication that data messages may be sent via the mesh link.

5. The method of claim 1, in which the virtual mesh link between the mobile mesh point and second connecting mesh point is realized by defining an Ether frame type encapsulating mesh management frames to be exchanged between the mobile mesh point and the second connecting mesh point.

6. The method of claim 5, wherein a message carrying said Ether frame type sent by the mobile mesh point is arranged to cause the second connecting mesh point to read a destination Media Access Control address therefrom, and
(i) if it is determined that the destination Media Access Control address is the second connecting mesh point, the virtual mesh link is established between said second connecting mesh point and the mobile mesh point,
(ii) otherwise, if it is determined that the destination Media Access Control address is not the second connecting mesh point, the second connecting mesh point forwards said frame according to the destination Media Access Control address.

7. A method according to claim 1 in which scanning for a connecting mesh point comprises determining a signal strength for the second connecting mesh point and a virtual mesh link is established between the mobile mesh point and the second connecting mesh point if the signal strength reaches or exceeds a pre-set first threshold.

8. A method according to claim 7 which comprises determining a signal strength for the second connecting mesh point after a virtual link is formed and the step of transforming the virtual link to a real link is carried out if the signal strength reaches or exceeds a pre-set second threshold, wherein said second threshold is greater than the first threshold.

9. (canceled)

10. A mobile mesh point comprising:
a mesh link unit to exchange data messages over a mesh link with a connecting mesh point;
a scanning unit to detect connecting mesh points with which to establish a mesh link;
a virtual mesh link establishing unit; and
a mesh link transforming unit;
wherein the virtual mesh link establishing unit is to establish a virtual mesh link to a second connecting mesh point if, in use of the mobile mesh point and while the mobile mesh point has an existing mesh link with a first connecting mesh point, and the scanning unit detects a second connecting mesh point, wherein virtual mesh link unit is to establish the virtual mesh link by exchanging messages with the second connecting mesh point via the existing mesh link with the first connecting mesh point and a link between the first and second connecting mesh points, the messages comprising messages to establish a real mesh link; and
the mesh link transforming unit is to transform the virtual mesh link into a real mesh link.

11. A mobile mesh point according to claim 10 wherein the scanning unit is to determine the communication channel of a connecting mesh point, and the mobile mesh point comprises a communication channel control unit to change the communications channel on which messages are sent by the mobile mesh point if the first connecting mesh point has a different communication channel to that of the second connecting mesh point.

12. A mobile mesh point according to claim 10 comprising a signal strength unit to determine the strength of a signal from a connecting mesh point and the virtual mesh link establishing unit is to establish a virtual mesh link if the signal strength reaches or exceeds a predetermined threshold.

13. A mobile mesh point according to claim 10 comprising a signal strength unit to determine the strength of a signal from a connecting mesh point and the virtual mesh link transforming unit is to transform the virtual mesh link to a real mesh link if the signal strength reaches or exceeds a predetermined threshold.

14. A connecting mesh point comprising:
a communication unit to communicate with a further connecting mesh point having a real mesh link to a mobile mesh point, and to exchange messages with the mobile mesh point via the further connecting mesh point, said messages comprising messages to establish a mesh link between the connecting mesh point and the mobile mesh point;
a virtual mesh link establishing unit to use the messages to establish a virtual mesh link with the mobile mesh point, said virtual mesh link being transformable into a real mesh link; and
a mesh link unit to exchange data messages over a mesh link with the mobile mesh point once the virtual mesh link has been transformed into a real mesh link.

15. A mesh network comprising a mobile mesh point and a first and second connecting mesh point that can establish mesh links to said mobile mesh point and a link between the first and second connecting mesh points,
wherein said mobile mesh point comprises:
a mesh link unit to exchange data messages over a mesh link with a first connecting mesh point; a scanning unit to detect other connecting mesh points with which to establish a mesh link; a virtual mesh link establishing unit; and a mesh link transforming unit; wherein the virtual mesh link establishing unit is to establish a virtual mesh link to the second connecting mesh point if, in use of the mobile mesh point, the scanning unit detects the second connecting mesh point, wherein the virtual mesh link unit is to establish the virtual mesh link by exchanging messages with the second connecting mesh point via the mesh link with the first connecting mesh point and the link between the first and second connecting mesh point, the messages comprising messages to establish a real mesh link; and the mesh link transforming unit is to transform the virtual mesh link into a real mesh link;
and said second connecting mesh point comprises:
a communication unit to exchange messages with the mobile mesh point via the link between the first and second connecting mesh points, said messages comprising messages to establish a mesh link between the second connecting mesh point and the mobile mesh point; a virtual mesh link establishing unit to use the messages to establish the virtual mesh link with the mobile mesh point; and a mesh link unit to exchange data messages over a mesh link with the mobile mesh point once the virtual mesh link has been transformed into a real mesh link.
